(19) United States
(12) Patent Application Publication
(10) Pub. No.: US 2023/0077732 A1
(43) Pub. Date: Mar. 16, 2023

(54) VIDEO GAME CONTROLLER WITH SELECTABLE LOADOUTS

(71) Applicant: Voyetra Turtle Beach Inc., White Plains, NY (US)

(72) Inventors: Daniel Adam Nuth, Newport (GB); Daniel Stuart-Cross, Newport (GB)

(21) Appl. No.: 17/477,338

(22) Filed: Sep. 16, 2021

(51) Int. Cl. A63F 13/26; A63F 13/24

(52) U.S. Cl. CPC A63F 13/26; A63F 13/24

(57) ABSTRACT

This disclosure describes a system that allows a user to generate and select loadouts from a game controller. These loadouts may be displayed on a screen of the game controller. In addition to the game controller, the disclosed system may comprise an app, on a device external from the game controller, that is also able to generate and display the loadouts.

### BACKGROUND

Limitations and disadvantages of conventional game controllers will become apparent to one of skill in the art, through comparison of such game controllers with some aspects of the present system set forth in the remainder of this disclosure with reference to the drawings.

### BRIEF SUMMARY

A video game controller with selectable loadouts is provided substantially as illustrated by and/or described in connection with at least one of the figures, as set forth more completely in the claims.

### BRIEF DESCRIPTION OF THE DRAWINGS

FIG. 1 illustrates an exemplary video game controller with a graphical user interface displaying a menu in accordance with aspects of this disclosure.

FIG. 2A illustrates an exemplary video game controller with a graphical user interface displaying a loadout screen with a loadout icon in accordance with aspects of this disclosure.

FIG. 2B illustrates an exemplary video game controller with a graphical user interface displaying a loadout screen and a pop-up notification in accordance with aspects of this disclosure.

FIG. 3A illustrates an exemplary video game controller and an associated app running on a mobile device in accordance with aspects of this disclosure.

FIG. 3B illustrates an exemplary video game controller and a screen layout for customizing a loadout in accordance with aspects of this disclosure.

### DETAILED DESCRIPTION

This disclosure describes a game controller system that allows a user to access and adapt the features of a game controller as well as secondary actions associated with the gaming experience. The disclosed game controller system may comprise an application (“app”), on a device external from the game controller, that is operable to adjust settings and loadouts of the game controller. These settings and loadouts are viewable, by the user, from a screen on the game controller. The app may be a PC app, a windows app, or a Mac app. The app may also be a mobile app for a smartphone and/or tablet.

Certain embodiments of the disclosure may be found in a game controller with a user interface. In accordance with various embodiments of the disclosure, a device, such as a smartphone or tablet, may control settings and loadouts, used by the game controller, that may be displayed on the user interface of the game controller. The device may adapt and adjust the settings and loadouts even while the game controller is being actively used during a game. The device may communicate with the game controller wirelessly via Bluetooth, Wi-Fi, or any other wireless protocol. The game controller, disclosed herein, is not platform-specific and may communicate with a game console wired or wirelessly via Bluetooth, Wi-Fi, or any other wireless protocol.

The disclosed game controller system offers an integrated loadout hub. In addition, the disclosed game controller system also delivers innovative applications of technology that improve a user's experience.

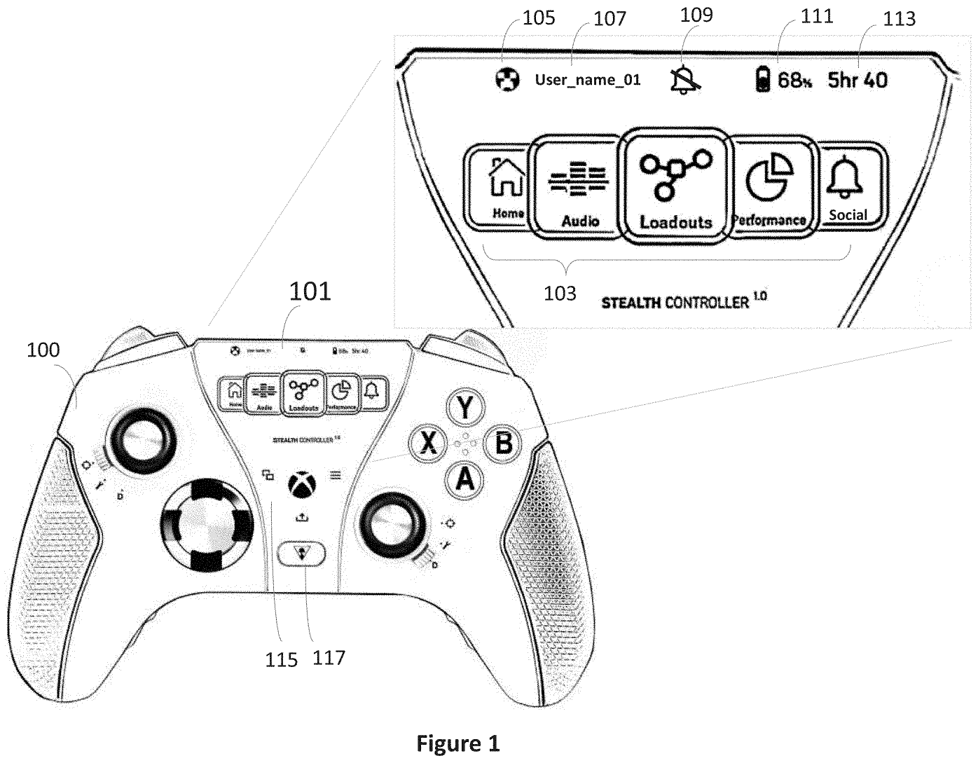

FIG. 1 illustrates an exemplary video game controller 100 with a graphical user interface 101 displaying a menu. The game controller 100 is configured to operate a video game and also comprises a memory, a processor and a screen 101. The video game may comprise a PC game, a console game, a mobile game a Mac game or any other electronic game. The memory in the game controller 100 is configured to store data associated with the game controller 100. The processor in the game controller 100 is configured to access the memory. The screen 101 is operably coupled to the processor and is configured to display the data to the user of the game controller 100. The game controller 100 may comprise a wireless interface that is operable to communicate directly with a video game console. A dongle may be plugged into the video game console to allow the wireless communication. For example, a USB connection on the video game console may be adapted, via the dongle, to communicate with the game controller 100 via Bluetooth, Wi-Fi or any other wireless protocol.

The screen 101 is integrated into the game controller 100. The screen 101 may comprise a graphical user interface and a touch screen. For example, the screen 101 may comprise a capacitive touch display. The screen 101 may also comprise a high resolution display with deep blacks and rich color. The screen 101 may be covered by a tempered glass that may be configured with smooth 3D curves on the edges.

The screen 101 may display programmable settings, loadouts, and/or metrics. What and how elements are displayed is adjustable, via the processor, even while the game controller 100 is in use. The display on the screen 101 may provide a quick, in-game access to the settings, loadouts, and/or metrics. The game controller 100 may comprises one or more buttons 117 for controlling what is displayed on the screen 101. The game controller 100 may also comprises one or more backlit controls 115.

The graphical user interface 101 in FIG. 1 illustrates a menu of core features 103, a user icon 105, user name 107, a communication setting 109, a battery charge level 111, and an estimate time 113 until a battery must be recharged. This menu is a user-customizable dashboard that can be designed and redesigned by a user as desired for easy access to most frequently used features and to provide an overview of the controller 100 status. For example, an intuitive user interface may allow a user to quickly and easily change settings as desired.

Because the screen 101 is operable to display a customizable, user interface, the user interface may be configured to indicate primary features of the game controller and secondary features/actions of the game experience. The menu carousel 103 may be selectable by touch or the core feature set hubs may be accessed using the button 117. As illustrated in FIG. 1, the core hubs may comprise Home, Loadouts, Audio, Performance and Social.

The user icon 105 and user name 107 may be selectable according to who is using the game controller 100 at any given time. The communication setting 109 may toggle between allowing and blocking communication via social media and other communication devices. The processor in the game controller 100 may be operable to control communication from an external device.

The game controller 100 may comprise a rechargeable battery. The battery charge level 111 and the estimate time 113 until a battery must be recharged are useful for indicating when a battery needs to be swapped or recharged. Recharging may be performed via a cable or a dedicated cradle.

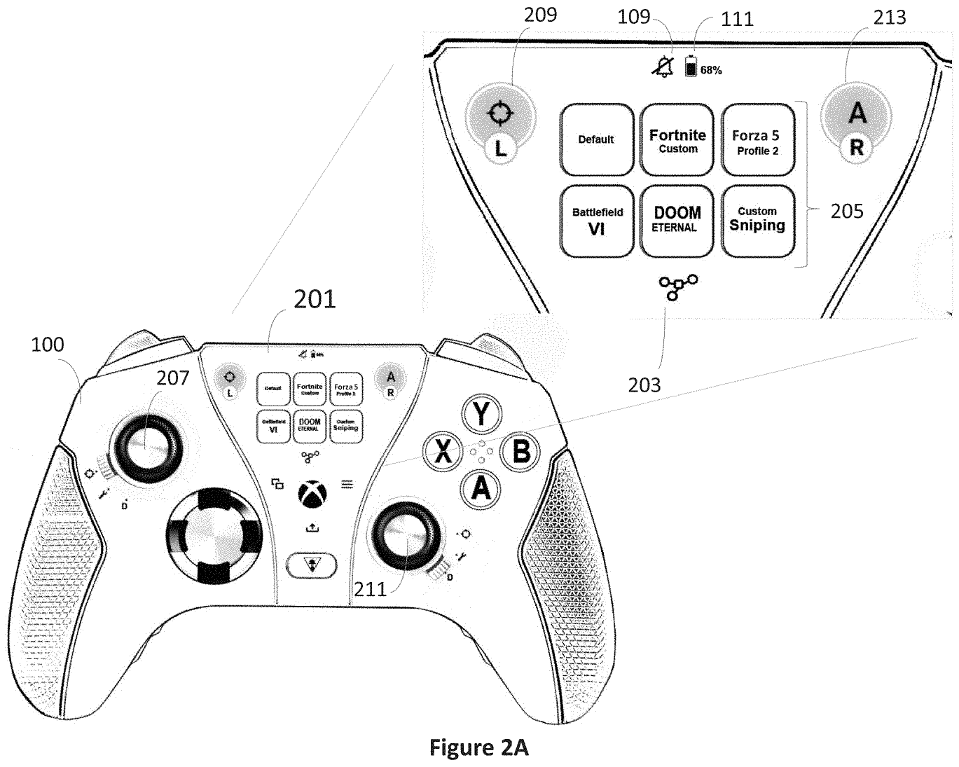

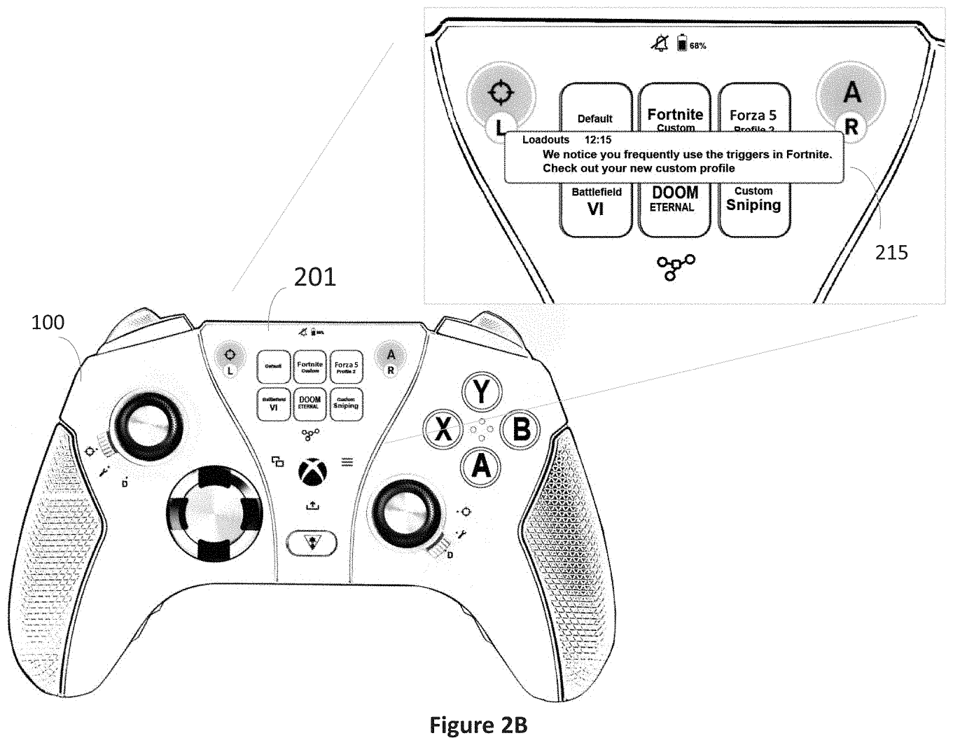

FIG. 2A illustrates an exemplary video game controller 100 with a graphical user interface displaying a loadout screen 201, which may be identified via the loadout icon 203.

As will be discussed in more detail below, the one or more loadouts 205 may be selectable via the screen 201.

The screen 201 may allow a user to select the functionality of the left thumbstick 207 via a button 209. Likewise, the screen 201 may also allow a user to select the functionality of the right thumbstick 211 via another button 213. As displayed, the left thumbstick 207 is mapped to the crosshair movement, and the right thumbstick 213 is mapped to the abilities (“A”) selection.

The loadout screen 201 may also comprise the communication setting indicator 109 and the battery charge level indicator 111 as described with reference to the exemplary display 101 in FIG. 1.

FIG. 2B illustrates an exemplary video game controller 100 with a graphical user interface displaying a loadout screen 201 and a pop-up notification 215.

An app running on the game controller 100 may monitor and analyze a user's performance and controller usage. According to this monitoring and analysis the game controller 100 may personalize a profile within a loadout to help a user improve their gameplay. This automatic generation of profiles may be based on past usage. A user may be given an option to select the automatically-generated, personalized profile and/or loadout via the notification 215.

The generation (manual and/or automatic), storage and communication of profiles/loadouts may be performed via an application that runs on the game controller 100, a computer, a mobile device, an edge computing device and/or a cloud computing device. The layout of a loadout screen 201 may be designed, controlled and displayed via an application that runs on the game controller 100, a computer and/or a mobile device.

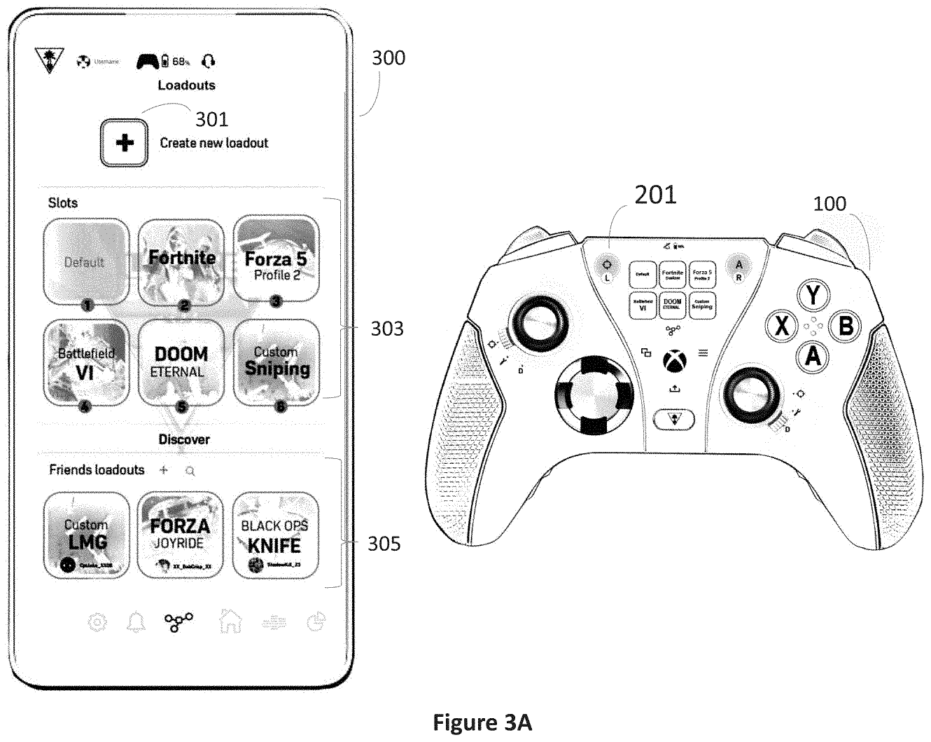

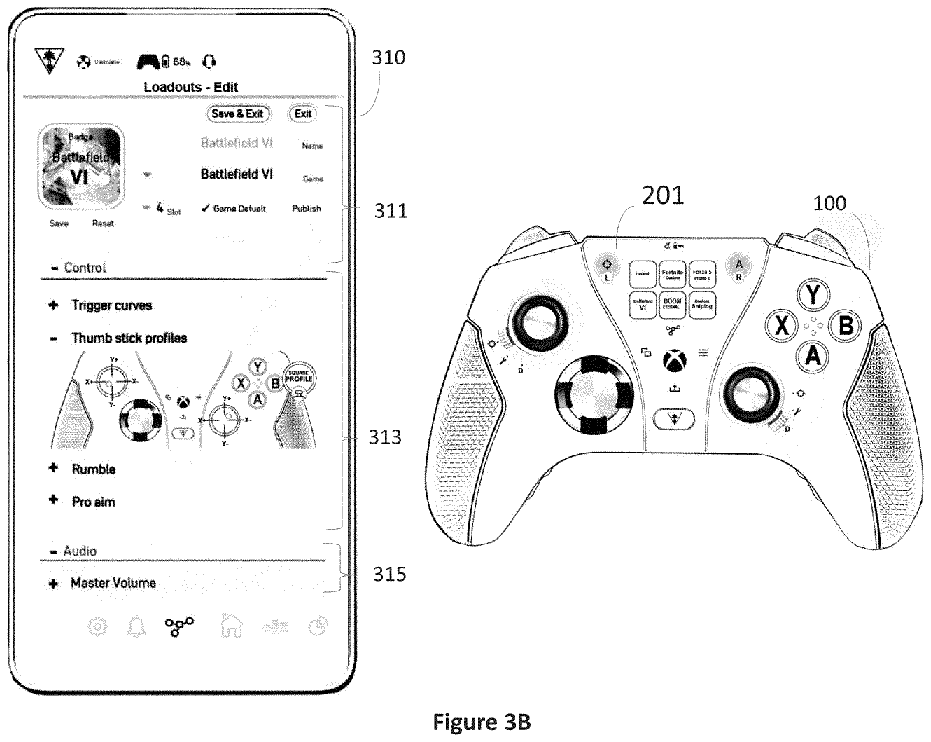

FIG. 3A illustrates an exemplary video game controller 100 and an associated app 300 running on a mobile device. As illustrated, the app 300 on the mobile device is used to configure and dynamically display and control the loadout screen 201 on the game controller 100. As will be described in further detail below, the app 300 on the mobile device may be used to configure/create a new loadout via a selection 301 that opens a new screen layout. The app 300 may also be enabled to access storage of a cloud service provider and be powered by the cloud. The app 300 may provide full access to the game controller 100 to customize and improve performance.

As illustrated, a portion 303 of the app 300 may mirror the loadout screen 201. In this example, there are loadouts labeled, Default, Fortnite, Forza 5 Profile 2, Battlefield VI, Doom Eternal, and Custom Sniping.

The elements of the app 300 may also provide additional loadouts. The app may display loadouts 305 from a user's friends. In this example, there are additional loadouts labeled Custom LMG, Forza Joyride, and Black Ops Knife. A user may have the options to add one of their friend's loadouts.

FIG. 3B illustrates an exemplary video game controller 100 and a screen layout 310 for customizing a loadout. As illustrated, the screen layout 310 on the mobile device is used to configure a particular loadout.

In a first portion of the screen layout 311, the loadout name and a button design may be selected. A user may select where to place the loadout button and whether to publish/share the loadout with others.

In a second portion of the screen layout 313, adjustments to the mappable controls (i.e., game controller buttons, triggers, thumbsticks, etc.) may be made in real time using the integrated screen. For example, trigger curves may be programmed, thumbsticks profiles may be programmed, the intensity of rumble feedback may be selected, and pro aim may be fine-tuned. Thumbsticks profiles may comprise an axis offset, and axis inversion option and a deadband/dead zone setting.

In a third portion of the screen layout 315, a game's audio may be adjusted according to the loadout. For example, a headset may be coupled to a video game via the game controller 100. The game controller 100 may comprise an audio processor for altering audio sent to the headset and/or altering audio received from a microphone attached to the headset.

A non-transitory computer-readable medium storing a program may be operated by a processor on the external device via the app 300 and/or by a processor on the controller 100. The program may operably couple (e.g., via wireless communication such as Bluetooth, Wi-Fi and/or cellular protocols) a game controller 100 to a video game device and another device (e.g., smartphone). Once operably coupled, the program may communicate loadouts via the processor, thereby allowing one or more loadouts to be displayed on a screen 201 of the game controller 100.

While the present system has been described with reference to certain implementations, it will be understood by those skilled in the art that various changes may be made and equivalents may be substituted without departing from the scope of the present system. In addition, many modifications may be made to adapt a particular situation or material to the teachings of the present disclosure without departing from its scope. Therefore, it is intended that the present method and/or system not be limited to the particular implementations disclosed, but that the present system will include all implementations falling within the scope of the appended claims.

Throughout this disclosure, the use of the terms dynamically and/or adaptively with respect to an operation means that, for example, parameters for, configurations for and/or execution of the operation may be configured or reconfigured during run-time (e.g., in, or near, real-time) based on newly received or updated information or data. For example, an operation within a transmitter and/or a receiver may be configured or reconfigured based on, for example, current, recently received and/or updated signals, information and/or data.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise first “circuitry” when executing a first one or more lines of code and may comprise second “circuitry” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

1. A system comprising:
a game controller configured to operate a video game, the game controller comprising:
a memory configured to store one or more loadouts for the video game;
a processor configured to access the one or more loadouts, wherein the processor is operable to control social media communication from other communication devices; and
a screen, operably coupled to the processor, configured to display the one or more loadouts to a user of the game controller.

2. The system of claim 1, wherein the system comprises an application (“app”) configured to operate on a device external from the game controller, wherein the app is operable to generate the one or more loadouts and route the one or more loadouts to one or both of the game controller and the video game.

3. The system of claim 2, wherein the app is a mobile app and the device is a smartphone.

4. The system of claim 2, wherein the app is a mobile app and the device is a tablet.

5. The system of claim 1, wherein the one or more loadouts are displayed while the game controller is in use.

6. The system of claim 1, wherein:
the processor is operable to monitor a usage of the game controller,
the processor is operable to generate a custom profile according to the usage of the game controller, and
the screen is operable to display a message to the user regarding the custom profile.

7. The system of claim 1, wherein the screen is touch sensitive, and wherein the user is operable to select a loadout of the one or more loadouts by touching the screen of the game controller.

8. A method comprising:
storing a loadout for a video game in a memory of a game controller;
accessing, via a processor of the game controller, the loadout stored in the memory; and
displaying the loadout on a screen of the game controller; and
controlling social media communication from other communication devices.

9. The method of claim 8, wherein the method comprises:
displaying the loadout via an application (“app”) operating on a device external from the game controller.

10. The method of claim 9, wherein the app is a mobile app and the device is a smartphone.

11. The method of claim 9, wherein the app is a mobile app and the device is a tablet.

12. The method of claim 8, wherein the method comprises:
updating the loadout while the game controller is in use.

13. The method of claim 8, wherein the method comprises:
monitoring a usage of the game controller;
generating a custom profile according to the usage of the game controller; and
displaying a message to the user regarding the custom profile.

14. The method of claim 8, wherein the method comprises:
selecting the loadout from among a plurality of loadouts by touching the screen of the game controller.

15. A non-transitory computer-readable medium storing a program, wherein when operated by a processor, the program causes the processor to execute a method comprising:
storing a loadout for a video game in a memory of a game controller;
accessing the loadout stored in the memory;
displaying the loadout on a screen of the game controller; and
controlling social media communication from other communication devices.

16. A system, comprising: the video game controller, wherein the video game controller comprises the non-transitory computer-readable medium, of claim 15, and the processor.

17. A system, comprising: a mobile device, external to the video game controller, wherein the mobile device comprises the non-transitory computer-readable medium, of claim 15, and the processor.

18. The system of claim 17, wherein the mobile device is one of a smartphone and a tablet.

19. The non-transitory computer-readable medium of claim 15, wherein the method comprises:
monitoring a usage of the game controller;
generating a custom profile according to the usage of the game controller; and
displaying a message to the user regarding the custom profile.

20. The non-transitory computer-readable medium of claim 15, wherein the method comprises selecting the loadout from among a plurality of loadouts by touching the screen of the game controller.
